(19) United States
(12) Patent Application Publication
(10) Pub. No.: US 2003/0037144 A1
(43) Pub. Date: Feb. 20, 2003

(54) Collaborative content programming

(75) Inventors: Florian Pestoni, Mountain View, CA (US); Joel L. Wolf, Golden Bridge, NY (US)

Correspondence Address: LACASSE & ASSOCIATES, LLC, 1725 DUKE STREET, SUITE 650, ALEXANDRIA, VA, 22314, US

(73) Assignee: INTERNATIONAL BUSINESS MACHINES CORPORATION

(21) Appl. No.: 09/928,347

(22) Filed: Aug. 14, 2001

(51) Int. Cl. G06F 15/173

(52) U.S. Cl. 709/226

(57) ABSTRACT

A method and system give an audience the ability to gain more control over the content they receive. The system learns about each user's individual preferences and builds profiles for users and channels. The content for a given channel is selected either directly by the users or indirectly by software that uses a collaborative content programming method. Collaborative content programming offers an intermediate solution in which users with similar preferences jointly decide what content is included in a specific channel.

### RELATED APPLICATIONS

The present application is related to co-pending application entitled “Method, Computer Readable Media and Apparatus for the Selection and Rendering of Audio Files in a Networked Environment,” assigned to the same assignee as the present application, which is incorporated herein by reference.

### BACKGROUND OF THE INVENTION

1. Field of Invention

The present invention relates generally to the field of media content programming. More specifically, the present invention is related to user initiated collaborative content programming.

2. Discussion of Prior Art

Broadcasting has traditionally been the preferred approach to content distribution. Ways of distribution include radio, television and cable, as well as other media such as newspapers and magazines. A characteristic of traditional broadcasting has been that the audience (alternatively listeners, viewers, readers, etc.) plays a passive role, with only an indirect effect on the actual content that is delivered. Typically, the owners of a distribution channel select content according to their interpretation of the collective preferences of their target audience. The selected content is then distributed to the user with the hope that their needs and preferences are satisfied.

Cable TV channels, for instance, are becoming more specialized by strictly creating programming channels with specific topics or subjects, such as history, classic movies, or nature. Management of these content delivery enterprises choose a content category based on numerous factors, typically potential size and profile of the target audience, revenue streams (e.g., advertising, subscription fees), competitive offerings, etc. After analyzing the potential profits of these categories, programming managers are then responsible for selecting the specific content that is broadcasted.

Similarly, in the case of music radio stations, many stations adopt a musical style (e.g., country-western, blues, pop), and exclusively play music corresponding to that style. Presently there are numerous web content delivery services emphasizing music delivery to users according to their music styles and tastes. One feature available is a system wherein users select songs and the system then finds a number of other songs that sound similar to those selected. These songs, however, are specified, or found through search engines that find songs by genre or a pre-assigned description (e.g., heavy metal, country, etc.).

Other web content systems allow users to become a disc jockey and design a station tailored to their musical tastes. Members design their streaming music station by rating songs, artists, and albums, and through this, the system determines users' preferences. This process, however, can be an inconvenience to those who just want to listen to music rather than take the time to create a station.

As seen, recent technological developments have made it possible to have a practical means for the audience to communicate back to the distribution channel. However, this capability has not significantly affected the way in which content is selected. Even the adoption of the Internet by consumers and the emerging capability of delivering content have failed to produce significant improvements for selecting content. Examples of prior art systems using user preferences to filter content or variations thereof are described below.

Launch.com's “launchcast”, Wired Planet's website listen.com and Microsoft's® MongoMusic are examples of user selectable music systems. These services may be protected by various trademarks and copyrights of the named companies.

U.S. Pat. No. 5,740,549 discusses an information and advertising distribution system in which a data server stores and updates a database of information items and advertisements on a periodic basis. Profile data is obtained for subscribers and includes information such as viewing preferences and categories for which a subscriber does and does not want to view.

U.S. Pat. No. 5,774,170 describes a system and method for enhancing television and radio advertising by targeting, delivering, and displaying electronic advertising messages (commercials) within specified programming in one or more pre-determined households. Commercials can be delivered to specified homes or displays via over-the-air or wired delivery systems.

U.S. Pat. No. 6,002,393 provides a system and method for targeting TV advertisements to individual consumers by delivering a plurality of advertisements to a display site. A display of selected advertisements is suited for the individual consumer. Upon command, the system may also deliver advertisements to a viewing site.

U.S. Pat. No. 6,029,045 presents a system for communicating a programming data stream that is transmitted to a set-top box in a house of a user and stored in a predetermined portion of the pieces of local content data based on predetermined criteria. Based on a plurality of preferences predetermined by the user, the set-top box may also select a particular piece of local content to be inserted into the data stream.

U.S. Pat. No. 6,112,181 describes a matching and classification utility system for performing matching, narrow casting, classifying, or selecting material. The system includes assigning a user to a user class based on information and matching digital information with a user class based on associated rights management.

Whatever the precise merits, features and advantages of the above cited references, none of them achieve or fulfills the purposes of the present invention.

### SUMMARY OF THE INVENTION

A system and method for optimizing use of available media bandwidth assigns users to a “best-fit” scenario based on a combination of individual and aggregate user behavior. The system learns about each user's individual preferences and builds profiles for users and channels. The content for a given channel is selected either directly by the users or indirectly by software that uses a collaborative content programming method. Collaborative content programming offers an intermediate solution in which users with similar preferences jointly decide what content is included in a specific channel. The system also allows users to define multiple personae that represent different sets of preferences, moods, etc. that a single user may have at different times.

In a preferred embodiment, the media is Internet radio; the bandwidth a plurality of music channels and the method of content selection includes votes by many different users selecting songs. The votes are used in a collaborative manner so that the burden on each user to select desired programming content is lessened. A user is responsively shifted to a different station (channel) if the given station no longer fits the user's profile.

In one embodiment, the present invention predicts the likelihood that new songs will be liked by a station's audience, and does this in an active manner. This embodiment provides the opportunity to estimate user ratings for new content.

### BRIEF DESCRIPTION OF THE DRAWINGS

FIG. 1 illustrates a general process of developing a user's preferences and profile with musical choices.

FIG. 2 illustrates a general overview of the content selection process.

FIG. 3 illustrates a flow chart demonstrating the preferred embodiment for the selection process of receiving content/musical selections of the present invention.

FIG. 4 illustrates a detailed embodiment of developing a user's profile in the present invention.

FIG. 5 illustrates a system diagram of the present invention.

### DETAILED DESCRIPTION

The following method gives a content provider the ability to maximize bandwidth allocation, increase user loyalty, and enable the audience to gain more control over the content they receive via broadcasting networks. This method allows users to express their preferences by voting on the content they receive. These votes are then used to determine what content to deliver at any given point in time. Moreover, users are assigned to the channel(s) that best match their preferences.

While it is technically possible, and in some cases economically viable, to deliver content customized for an individual user, and give this user full control over the programming of this channel, this creates a burden on the user to completely specify what content should be delivered. At another extreme, traditional programming gives the user no control over the actual content other than selecting among multiple channels.

Collaborative content programming is an intermediate solution for a content provider to offer, within a designated bandwidth, channels in which users with similar preferences can jointly decide what content to include in the channel, thus sharing the burden of selecting the desired content. Users collaborate indirectly in the content selection process by letting their individual preferences be known to the system. General collaborative filtering is known in the art; however, the present invention utilizes an active approach to determine content programming for network distribution of materials based on user votes.

This method offers consumers the ability to create virtual communities around a topic many are passionate about, such as music or more generally content. Because the system learns from its users' preferences, and users jointly decide what content to include in the channel, it increases switching cost for consumers and fosters loyalty towards content providers. Further, the method and system of the present invention makes specific content (e.g., songs) recommendations based on a dynamically updated user matching scheme, that is, based on what a particular user does and what other users do (e.g., what content users request and how they vote). Thus, a user needs not select content from a given (and arbitrarily pre-defined) genre to be assigned to a particular station/channel.

In this model, the content for a given channel is selected either directly by the users (by requesting a title) or indirectly by software that considers the aggregate preferences of the users who have signed up for this channel. The system learns about each user's individual preferences and builds profiles for users and channels.

For a new user, for whom no preferences are known, the preferred embodiment presents several selections to that individual user (note that this is different from a regular channel, where many users may be participating.) This is solely for the purpose of building a profile, so the system can skip to the next selection as soon as the user casts a vote. The selections are chosen to capture the preferences of the user. For example, the first few selections may be drawn from the lists associated with channels that represent disjoint groups of users (to capture variety and some high-level preferences) whereas later selections can be used to fine-tune the preferences by choosing selections on “different but close” channels. Once again, this is done for each user, in fact for each persona, only once in order to build an initial profile and tentatively map the user to a channel. After users join a channel, they can continue casting votes and their profile will become more accurate with use.

Every time a user connects to the system, the list of channels is searched to find the one that best matches the user's profile. If no existing (i.e., active) channel is a good enough match, a new channel may be created if the bandwidth constraints allow it. The user is thus assigned to a channel, to which one or more users may be connected. The method assures that all users connected to a channel have similar preferences.

Users connected to a channel may either explicitly request content; may cast votes for or against content received over the channel; or may be completely passive and just listen to/view the content.

Users request content by selecting from the database of available content. In one embodiment, users may contribute their own content for all users on the same channel to receive. In another embodiment, the content is distributed throughout the network, and is added to each channel on demand.

The collaborative programming model selects content to be delivered to users over each channel. The model takes into consideration the users' profiles, the list of pending user requests (if any) the content database and the history of titles delivered over said channel. The model determines what titles are most likely to be within the aggregate set of preferences of all users actually connected to the channel, and delivers those titles. These may include titles that users on the channel have requested, or titles for which some of the users have expressed their preference. Additionally, the model can estimate, based on an aggregation of profiles, what each user's vote would be for a given title, even if no vote has been cast by the user for or against said title. Thus, the model can introduce new content that will, with high probability, be liked by all users in the channel. By updating title selections quickly and keeping the user interested, the system effectively rewards those listeners who take an active part in the voting process by selecting the content they like.

As previously described, new users are first individually exposed to a plurality of songs to develop an initial user profile and appropriate first guess matching channel. After this initial assignment, users may continue to cast votes. A particular user is responsively shifted to a different channel if a user no longer fits the collective preferences of the users of that channel. The listener may be passive, i.e. doesn't have to switch stations directly. The system does the matchmaking based on all assigned listeners, whose behavior may be predicted or actually measured by their votes.

Also, the present system preferably adapts to the dynamic nature of the audience. This ability of the system to learn and adapt is best exploited with content for which there is demand for repeat viewing. One example of such content is music, where extremely popular songs are maintained on radio stations' heavy rotation lists. Other examples exist in different areas of entertainment and news, such as children's movies, television programs, reports or articles by a certain author, etc. To dynamically adapt, as a user's profile is continuously updated, the system detects patterns in a user's behavior and learns to adapt, for example, by making selections based on the users actually connected or determining time of day in which each title is most desired. Thus the content provider bandwidth in use at any given time is maximized, while achieving the highest user satisfaction.

In the broadest sense, this invention is a system for modeling user preferences given an association with indirectly related knowledge. That is, data mining determines the association so the user doesn't have to perform a self-analysis survey.

A company operating under the present invention model would have the ability to deliver content over multiple channels simultaneously. The number of channels affects the degree to which individual user profiles can be met; for example, with only 10 channels, users would be aggregated in 10 groups, each group possibly having a broad base of preferences. The higher the number of channels, the best users' demands can be met. However, operating each additional channel represents an increase in cost.

Ultimately, the decision on how many channels to operate will be made based on cost-revenue targets but may be further limited by technical constraints and regulatory issues. Different cost structures apply depending on the broadcast technology adopted. In the case of the Internet, providing additional channels in general requires only a marginal cost.

An additional cost of providing this service would be the actual content. Several alternatives exist here, ranging from a centralized database of content to which users are restricted (and for which performance rights have been acquired directly by the service provider) to a collaborative effort on behalf of the consumers, who contribute their own content to be shared with other users (this would most likely require payment of licensing fees for public performance to copyright owners).

Revenue models used in traditional broadcasting can be applied to collaborative content programming. Subscription fees paid by the users or advertising revenue are the simplest. Even these two thoroughly tested revenue models have some new characteristics in the context of the present invention. Consumers' value is higher than in normal broadcasting since users have access to a highly customized channel. Similarly, advertisers may be able to make decisions based on users' interests and may also get feedback through the system's votes.

Depending on the underlying technology, the system is able to support other revenue models such as short-term subscriptions (for days or hours), pay-per-vote, pay-per-title, etc. With interactive delivery mechanisms such as the Internet, other sources of revenue are available as well. As part of the voting mechanism, users may select a “buy” option. When this applies to actual content, this will trigger a transaction to purchase the content for private viewing.

In the case of music delivery, for example, record labels may introduce new artists or titles in the collaborative content programming channels that best match the characteristics of new content; users can then indicate their preferences and also purchase and download the title. For tangible products such as portable music players, a targeted advertisement may generate transactions that may be completed online.

### PREFERRED EMBODIMENT

While this invention is illustrated and described in a preferred embodiment, the device may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

In this preferred embodiment, the media is Internet radio, the bandwidth is composed of a plurality of streaming audio channels and the method of content selection includes votes by many different users. The votes are used in a collaborative manner so that the burden on each user to select desired content is lessened. A user is responsively shifted to a different station (channel) if the given station no longer fits the user's profile.

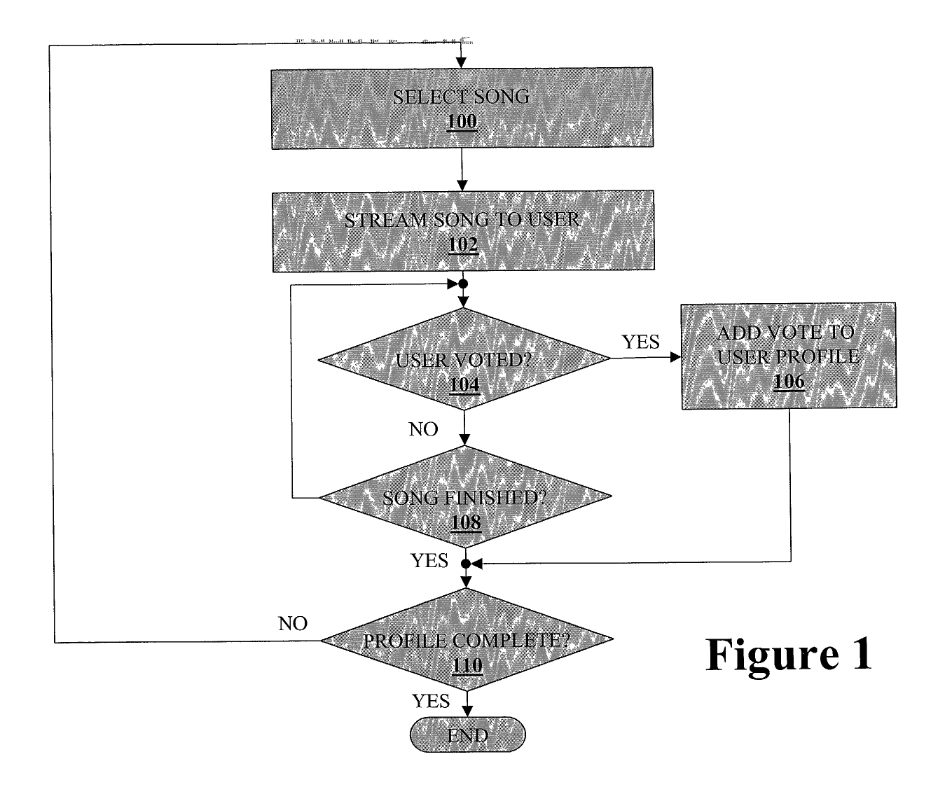

FIG. 1 illustrates the general process of determining a user's preferences and developing an initial profile with musical choices. A song is selected 100 from the server and streamed to the user for listening 102. The user can cast a positive, indifferent or negative vote 104, and this vote is noted and added to the user's profile 106. The process continues and repeats itself every time musical content is sent to the user until enough information is gathered about the user for an initial channel assignment (108 and 110).

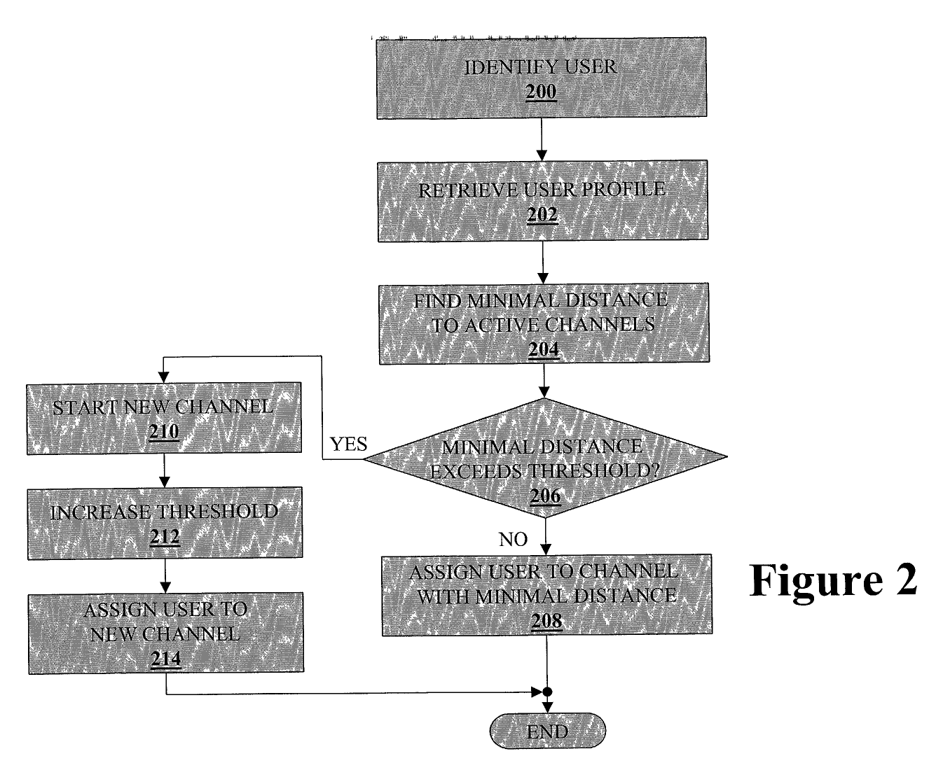

An overview of the channel matching process is shown in FIG. 2. This process assigns a specific channel to a user based on his or her profile, but also on the profiles of other users. When a new user connects, she must identify herself to the system 200 (e.g., userid/password, cookies, etc.) The system then retrieves the user's profile 202 and compares it to the profiles of all other currently connected users 204. This comparison is based on computing a “distance” between two user profiles: the smaller this distance, the closer the preferences of the corresponding users. Thus, by finding the channel in which this difference is minimal, the system selects the best match. If the distance between the profile of the connecting user and the closest channel exceeds a threshold 206, then a new channel is created 210, and the connecting user assigned to it 214. This threshold is adaptive and its value is increased 212 as the available bandwidth is used up, until no more new channels can be created, at which point connecting users will be matched to one of the active channels. If the distance from the user to the closest channel is below said threshold, the connecting user is assigned to an existing channel 208.

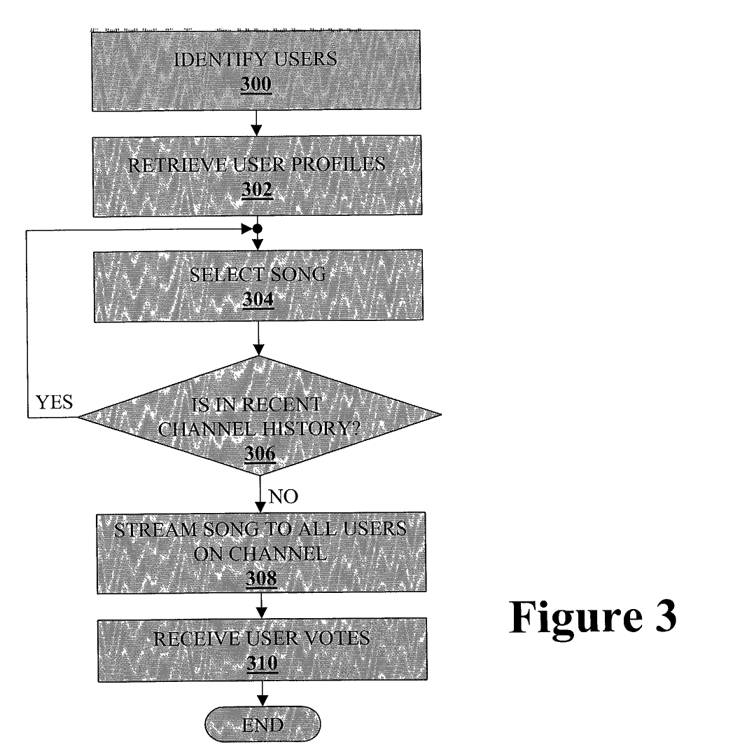

FIG. 3 illustrates the content selection process for the songs delivered by a specific channel. First, the system identifies all users connected to the channel 300 and retrieves their corresponding profiles 302. These profiles contain votes for or against songs that have been played in the past and are therefore in the song database. In some cases, the system may have explicit votes about this song from all users in the channel, and therefore can compute what percentage of these users like this song. In other cases, only some users will have cast a vote about this song; the system can then estimate the response of the other users on the channel based on these limited votes. In either case, the system selects a song 304 that, with high probability, will be liked by most users in the channel. Next the system checks the channel history 306 to guarantee that songs are not repeated more often than a certain (programmable) number of times per period of time (for example, once a day.) If the selected song does not match this criterion, a new one is selected and the process continues until a song is considered acceptable. This song is then streamed 308 to all users of the channel, who may choose to provide additional feedback to the system by casting new votes 310.

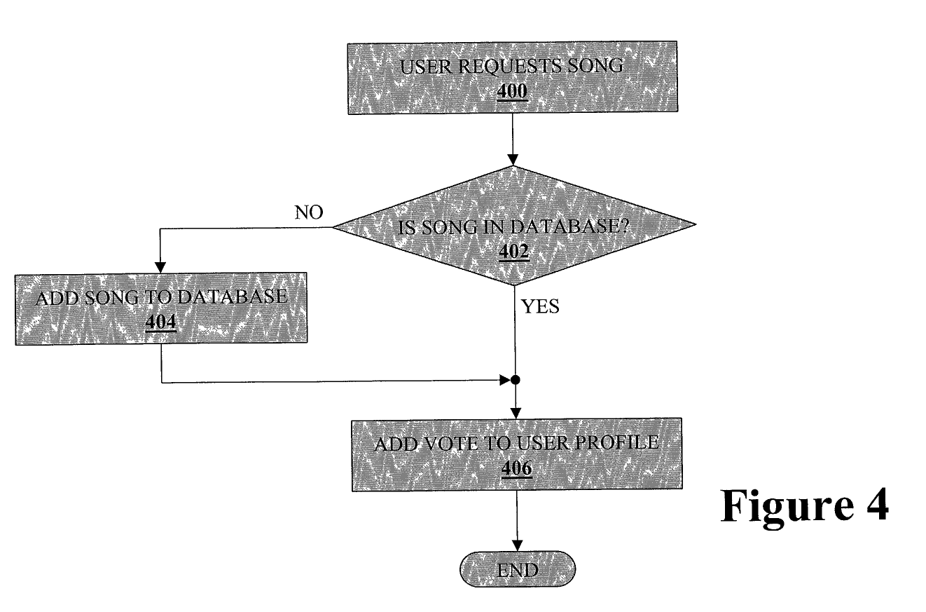

Users who are connected to a channel may request specific songs, as illustrated in FIG. 4. A user who is listening to a given channel may select a song 400 from the song database to indicate to the system his preference for this song. The system may also allow adding new content not previously included in the song database 402, in which case the song is added to said database 404. A user request is considered an implicit vote for this song, and this vote is added to the user's profile 406. This song request will be taken into consideration in step 304 when songs are selected by the system for streaming to users. Different criteria for merging user-initiated and system-initiated song selections are possible, the simplest one being to give higher priority to user requests. In this case, adopted in this preferred embodiment, whenever a user makes a request, this song is played on the corresponding channel before any other automatically selected songs are played. User requests have the effect of broadening the list of possible songs that the channel can play, thus adapting to the changing preferences of users and to the introduction of new content. The system can estimate, with a degree of certainty, what the reaction of other users will be to songs they have not yet evaluated, and indeed may not have heard yet.

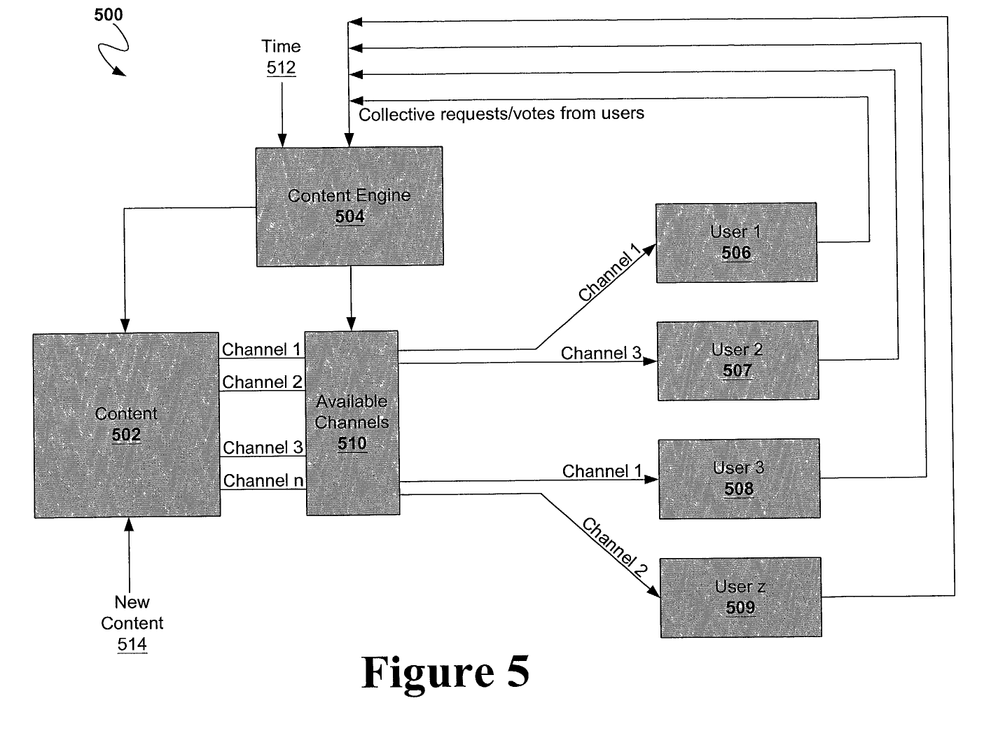

FIG. 5 illustrates the system 500 of the present invention. Content 502 represents computer storage of specified content such as songs, news, etc. This content is stored in a database and in some embodiments is distributed over multiple databases (e.g., songs located on various web servers distributed across the web). Content engine 504 drives the model of the present invention and includes computer processing, software (e.g., data mining algorithms), feedback inputs, time of day input, etc. Content engine 504 collects similar content located in 502 into channels 1-n (e.g., streaming audio channels). These channels are available to a multiplicity of users (1-z) 506-509 (those requesting access to the content) in distributor 510. Content channels are first selected for a requesting user, for example user 1 506, based on the history of specified content title requests and evaluations, which together represent a profile of preferences). A best match algorithm in the content engine 504 chooses, in this example, channel 1 to broadcast to the requestor 506. Other requestors are also connected to channels best matching their requests. Users then register votes for or against specific instances of content (including new content 514) within the channel they are connected to. This feedback is collected from multiple users connected to the same channel; in this case user 1 506 and user 3 508, and is used to determine future content of the specified channel. In addition, the feedback is used to redirect the requestor to a new channel when the feedback indicates a new best match. Time of day 512 is also used, in alternative embodiments, to alter content or channel connections, based on user/group behavior as previously described above.

Although musical content from web distribution centers has been used as the preferred example, the system may also be used with cable or satellite channels with a low-bandwidth user feedback channel (e.g., a modem periodically sends user votes and preference data back to the distribution center). The system may also be used for video, software, personal ads, news stories, restaurant rating, evaluating advertisements, and political propositions including matching candidates and issues.

### CONCLUSION

A system and method has been shown in the above embodiments for the effective implementation of collaborative content programming. While various preferred embodiments have been shown and described, it will be understood that there is no intent to limit the invention by such disclosure, but rather, it is intended to cover all modifications and alternate constructions falling within the spirit and scope of the invention, as defined in the appended claims.

The above enhancements and described functional elements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the arts of database or network programming.

1. A method of optimizing bandwidth allocation based on selective filtering, distribution of content and allocation of users to said distributed content, one or more steps of said method performed over a network, said method comprising:
dynamically allocating said bandwidth to a plurality of communication channels, each of said channels retaining one or more instances of content;
recursively receiving user preferences of content information from multiple users, said preferences comprising one or more of: selection requests for specific content, evaluations of existing content, and evaluations of potential content;
dynamically retaining within a selected channel a collection of specific instances of content based on an a collation of said preferences, said collection placed on an allocated communication channel over a period of time;
dynamically allocating user access to said one or more dynamically allocated communication channels based on a best match with said preferences.

2. A method of optimizing bandwidth allocation based on selective filtering, distribution of content and allocation of users to said distributed content, as per claim 1, wherein said evaluations of existing and potential content represent user preferences based on voting for or against the content.

3. A method of optimizing bandwidth allocation based on selective filtering, distribution of content and allocation of users to said distributed content, as per claim 1, wherein said evaluations of potential content comprises introduction of new content which, based upon a comparison with said collected content, appears to be a high probability match and said evaluations are used to validate or invalidate said match.

4. A method of optimizing bandwidth allocation based on selective filtering, distribution of content and allocation of users to said distributed content, as per claim 1, wherein said instances of content comprise selected songs.

5. A method of optimizing bandwidth allocation based on selective filtering, distribution of content and allocation of users to said distributed content, as per claim 1, wherein said distribution of content comprises distributing selected songs across the Internet to a user.

6. A method of optimizing bandwidth allocation based on selective filtering, distribution of content and allocation of users to said distributed content, as per claim 1, wherein said distribution of content comprises distributing selected songs across the Internet and said communication channels comprise streaming audio channels.

7. A method of optimizing bandwidth allocation based on selective filtering, distribution of content and allocation of users to said distributed content, as per claim 1, wherein said distribution of content comprises distributing selected electronic content to a user from any of: web distribution centers, cable television systems, and satellite systems.

8. A method of optimizing bandwidth allocation based on selective filtering, distribution of content and allocation of users to said distributed content, as per claim 1, wherein said distribution of content comprises distributing selected electronic content comprising any of: video, software, personal ads, news stories, restaurant ratings, evaluating advertisements, and political propositions including matching candidates and issues.

9. A method of optimizing bandwidth allocation based on selective filtering, distribution of content and allocation of users to said distributed content, as per claim 1, wherein said step of allocating user access to one or more dynamically allocated communication channels comprises dynamically providing said access based on a match of a specific user's collaborative preferences with that of the collaborative preferences of the allocated channel.

10. A method of optimizing bandwidth allocation based on selective filtering, distribution of content and allocation of users to said distributed content, as per claim 1, wherein a new user is mapped to an initial content channel by building a new user profile comprising the steps of presenting a plurality of content selections to the user and registering positive and negative votes of said content selections.

11. A collaborative content programming system, one or more elements of said system located across networks, said system comprising:
a content database, said content database retained within one or more storage locations across said network;
a content engine, said content engine collecting specific instances of content retained in said content database into channels;
an available channel selector, said selector providing access to said channels to content requesters;
said content engine determining a best match to connect each of said content requesters to one or more of said available channels based on specific content requests;
said content engine aggregating said specific content requests and requestor evaluations of specific content, and
said content engine dynamically modifying said collected specific instances of content retained in said content database into channels based on said aggregating.

12. A collaborative content programming system, as per claim 11, wherein said evaluations comprise voting on existing and potential content, said voting representing user preferences.

13. A collaborative content programming system, as per claim 12, wherein said evaluations of potential content comprises introduction of new content which, based upon a comparison with said collected content, appears to be a high probability match and said evaluations are used to validate or invalidate said match.

14. A collaborative content programming system, as per claim 11, wherein said content comprises selected songs.

15. A collaborative content programming system, as per claim 11, wherein said content is broadcast across the Internet.

16. A collaborative content programming system, as per claim 11, wherein said content is broadcast across the Internet and said channels comprise streaming audio channels.

17. A collaborative content programming system, as per claim 11, wherein said content is broadcast to a requestor from web distribution centers.

18. A collaborative content programming system, as per claim 11, wherein said content is broadcast across said channels from any of: web distribution centers, cable television systems, and satellite systems.

19. A collaborative content programming system, as per claim 11, wherein said content comprises any of: video, software, personal ads, news stories, restaurant ratings, evaluating advertisements, and political propositions including matching candidates and issues.

20. A collaborative content programming system, as per claim 11, wherein said evaluations additionally include requests for omission of specific content.

21. A collaborative content programming system, as per claim 11, wherein said content engine comprises at least data mining algorithms.

22. An e-commerce model for collaborative content programming with electronic access to user modified channels of content, said model comprising:
a collection of individual content selections, said collection retained within computer storage and accessible across computer networks;
computer software, said software tracking and aggregating both individual user's requests based on specific content selections and evaluations of specific selections from said collection, said aggregated requests and evaluations retained locally or remotely in associated computer storage;
one or more channels, said channels dynamically collecting specific content based on said aggregated requests and evaluations, said computer software assigning users to a best matching channel, said channels accessible remotely by said users across said networks, and
revenue collection based on any of: subscription fees, per content fee, advertising, and content purchase options.

23. An article of manufacture comprising a computer usable medium having computer readable program code embodied therein which selective filters and distributes content based on combined user specific and collaborative inputs, said computer readable program code comprising:
computer readable program code for allocating a communication channel for one or more instances of content;
computer readable program code for recursively receiving content information from multiple users, said content information comprising one or more of: selection requests for specific content, evaluations of existing content, and evaluations of potential content;
computer readable program code for collecting specific instances of content based on said content information, said collected content placed on said allocated communication channel over a period of time, and
computer readable program code for allocating user access to one or more allocated communication channels based on said received content information.
